(19) United States
(12) Patent Application Publication
(10) Pub. No.: US 2011/0063441 A1
(43) Pub. Date: Mar. 17, 2011

(54) IMAGER AND SURVEILLANCE SYSTEM

(75) Inventors: Yasuhiro ASA, Tama (JP); Seiichi HIRAI, Koshigaya (JP); Hideaki UCHIKOSHI, Kodaira (JP)

(73) Assignee: Hitachi Kokusai Electric Inc.

(21) Appl. No.: 12/844,085

(22) Filed: Jul. 27, 2010

(30) Foreign Application Priority Data
Sep. 11, 2009 (JP) 2009-209956

(51) Int. Cl. H04N 7/18

(52) U.S. Cl. 348/143; 348/E07.085

(57) ABSTRACT

Disclosed is a surveillance system that detects a suspicious person immediately without fail and presents the detected suspicious person to a surveillant even when the system includes a large number of networked surveillance cameras. An imager included in the surveillance system retains a dynamically-updatable suspicious person list within itself and detects a suspicious person in accordance with a feature amount extracted from an image.

### CLAIM OF PRIORITY

The present application claims priority from Japanese Patent Application JP2009-209956 filed on Sep. 11, 2009, the content of which is hereby incorporated by reference into this application.

### BACKGROUND OF THE INVENTION

(1) Field of the Invention

The present invention relates to an imager and a surveillance system that are used to detect a face image of a suspicious person from a surveillance image.

(2) Description of the Related Art

When a suspicious person is to be detected in an image picked up by a surveillance camera, a suspicious person in a surveillance image is automatically detected in accordance with preregistered suspicious person data (hereinafter referred to as a suspicious person list) and presented to a surveillant for the purpose of providing enhanced surveillance efficiency.

A security system disclosed, for instance, in Japanese Patent Application Laid-Open Publication No. 2009-59222 detects a suspicious person by comparing a face image detected from a surveillance image against a suspicious person face image registered in a suspicious person list. Further, when this security system detects a suspicious action, it registers a face image of a person performing the suspicious action in the suspicious person list even if the face image does not agree with face images preregistered in the suspicious person list.

### BRIEF SUMMARY OF THE INVENTION

Meanwhile, the security system described in Japanese Patent Application Laid-Open Publication No. 2009-59222 is configured so that the functionality for suspicious person detection and registration is independent of surveillance cameras. No problems occur as far as the number of targeted surveillance cameras is small. However, if a large number of surveillance cameras are targeted, the image transmission load on a network increases. This increases the possibility, for instance, of reducing the frame rate for image transmission or causing a transmission delay. This may result in an inability to acquire a surveillance image of a suspicious person with appropriate timing, thereby losing sight of the suspicious person. The present invention has been made to address the above-described problem, and provides a surveillance system that detects a suspicious person immediately without fail and presents the detected suspicious person to a surveillant even when the system includes a large number of networked surveillance cameras.

In order to address the above-described problem, according to an embodiment of the present invention, there is provided an imager for use in a surveillance system.

The imager includes a surveillance image acquirer, a face image detector, a feature amount generator, a suspicious person list, a data manager, a suspicious person discriminator, and a data input/output. The surveillance image acquirer acquires a picked-up surveillance image in real time. The face image detector detects a face image in the surveillance image. The feature amount generator generates the feature amount of the detected face image. The suspicious person list contains registered feature amounts that are generated from previously acquired suspicious person face images. The data manager performs an update process and access management for the suspicious person list. The suspicious person discriminator determines the degree of similarity (hereinafter referred to as the similarity) between a feature amount generated by the feature amount generator and a feature amount registered in the suspicious person list, and judges whether the detected face image depicts a suspicious person. The data input/output exchanges data over a network with another imager and a surveillance server that stores and distributes surveillance images. The greatest characteristic of the imager is to retain a dynamically-updatable suspicious person list within itself and detect a suspicious person in accordance with a feature amount extracted from an image.

The present invention makes it possible to immediately detect a suspicious person from all persons captured by an imager and present the detected suspicious person to a surveillant.

### BRIEF DESCRIPTION OF THE DRAWINGS

An embodiment of the present invention will be described in detail based on the following figures, wherein:

FIG. 1 is a schematic diagram illustrating a surveillance system that is equipped with an imager according to an embodiment of the present invention;

FIG. 2 is a schematic diagram illustrating a surveillance image list display of a surveillance server according to the embodiment of the present invention;

FIG. 3 is a schematic diagram illustrating a suspicious person list updater of the surveillance server according to the embodiment of the present invention;

FIG. 4 is a schematic diagram illustrating a person retriever of the surveillance server according to the embodiment of the present invention;

FIG. 5 is a diagram showing an equation used in accordance with the embodiment of the present invention;

FIG. 6 is a flowchart illustrating a typical operation of the imager according to the embodiment of the present invention;

FIG. 7 is a diagram illustrating an operation of the imager according to the embodiment of the present invention;

FIG. 8 is a flowchart illustrating a typical operation of the imager according to the embodiment of the present invention;

FIG. 9 is a diagram illustrating an operation of the imager according to the embodiment of the present invention;

FIG. 10 is a flowchart illustrating a typical operation of the imager according to the embodiment of the present invention;

FIG. 11 is a diagram illustrating an operation of the imager according to the embodiment of the present invention;

FIG. 12 is a diagram illustrating the structure of suspicious person list data for the imager;

FIG. 13 is a diagram illustrating the structure of surveillance data for the imager;

FIG. 14 is a diagram illustrating the structure of control data;

FIG. 15 is a diagram illustrating the structure of suspicious person list data for the surveillance server; and

FIG. 16 is a set of drawings illustrating typical screens displayed by a screen data generator.

### DETAILED DESCRIPTION OF THE INVENTION

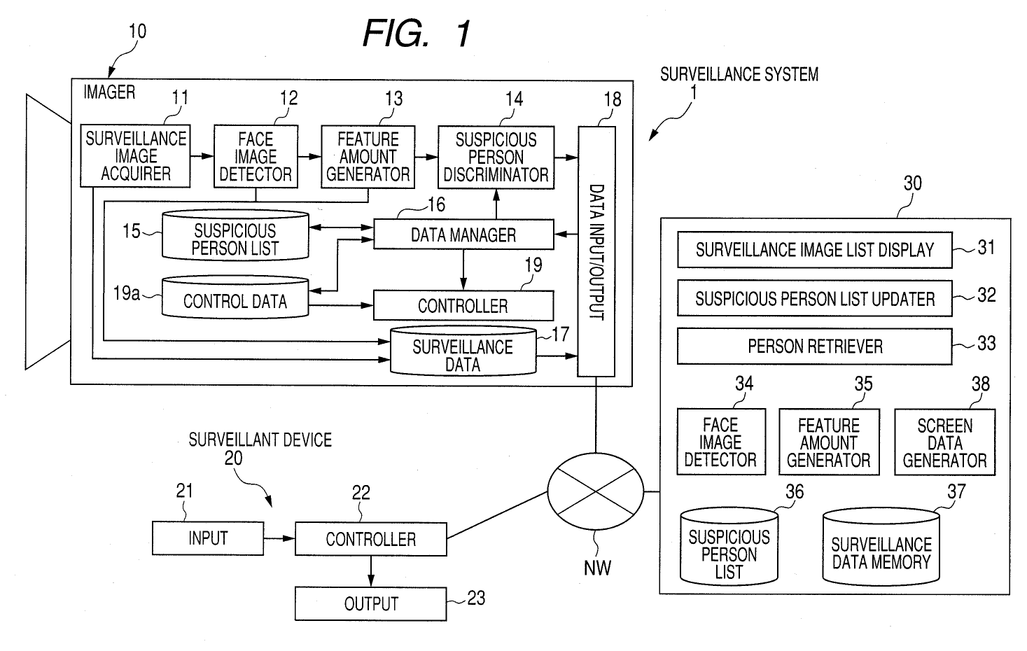

An embodiment of the present invention will now be described with reference to the accompanying drawings. Like elements are designated by the same reference numerals and will not be redundantly described. FIG. 1 is a schematic diagram illustrating a surveillance system that is equipped with an imager according to the present embodiment of the present invention.

As shown in FIG. 1, the surveillance system 1 according to the present embodiment of the present invention presents surveillance images of a predetermined surveillance region to a user (surveillant), and includes plural imagers 10, a surveillant device 20, and a surveillance server 30. The plural imagers 10, the surveillant device 20, and the surveillance server 30 are interconnected through a network NW to permit them to communicate with each other.

### <Imagers 10>

Each imager 10 is a device that picks up images of a predetermined surveillance region and detects a suspicious person in the picked-up surveillance images. This device includes a surveillance image acquirer 11, a face image detector 12, a feature amount generator 13, a suspicious person discriminator 14, a suspicious person list 15, surveillance data 17, a data manager 16, a data input/output 18, a controller 19, and control data 19a.

The surveillance image acquirer 11 can acquire a surveillance image as digital data in real time. For example, the surveillance image acquirer 11 may be a color CCD (Charge-Coupled Device). The acquired surveillance image is associated with a unique surveillance image ID and output to the face image detector 12 and surveillance data 17. In addition to the surveillance image and surveillance image ID, an imaging time and an imager ID that are associated with the surveillance image are also output to the surveillance data 17.

The face image detector 12 extracts a person's face from a surveillance image output from the surveillance image acquirer 11 and generates a face image. More specifically, the face image detector 12 recognizes the position of a face in accordance, for instance, with the size and shape of a skin-tone portion of the surveillance image, and generates a face image in accordance with the recognized face position. The generated face image is associated with a unique face ID and with the surveillance image ID, and output to the feature amount generator 13 and surveillance data 17.

The feature amount generator 13 generates the feature amount of a face image output from the face image detector 12. The feature amount data can be calculated by a publicly known method. A method disclosed, for instance, in Japanese Patent Application Laid-Open Publication 2008-257649 determines the brightness gradient between a target pixel of image data and individual pixels within an area peripheral to the target pixel and the direction of such a gradient, generates a histogram for each predetermined direction, and uses the direction of peak value acquisition as the feature amount of the target pixel. The peripheral area may be simply defined as an area formed by eight pixels around the target pixel.

The generated feature amount is associated with the surveillance image ID and with the face ID, and output to the suspicious person discriminator 14 and surveillance data 17.

The suspicious person discriminator 14 acquires a feature amount of a retained suspicious person list 15 through the data manager 16, calculates the similarity between a feature amount in the suspicious person list 15 and a feature amount output from the feature amount generator 13, and checks for highly similar feature amounts to determine whether a target face image depicts a suspicious person. In the present embodiment of the present invention, the similarity is represented by a parameter that decreases with an increase in similarity between two feature amounts. A publicly known method can be used to calculate the similarity. When, for instance, the aforementioned brightness gradient is used for feature amounts, the mean-square distance between feature amounts determined from two face images can be used. When, for instance, the two feature amounts are f(x₁, y₁) and f(x₂, y₂), respectively, the mean-square distance d between them is \sqrt{(x₁−x₂)²+(y₁−y₂)²} as indicated by the equation in FIG. 5. If the calculated similarity parameter value representing the similarity is smaller than a predetermined threshold value, it is judged that the two face images depict the same person. The threshold value is predetermined for a specific imager in accordance with average similarity between face images that should be judged to be the face images of the same person. The above judgment result is associated with the surveillance image ID and the face ID, and output to the data input/output 18.

In accordance with information that is output from the suspicious person discriminator 14, the data input/output 18 extracts the associated data from the surveillance data 17 and generates output data. Data stored as the surveillance data 17 includes a surveillance image, surveillance image ID, imaging time, and imager ID, which are output from the surveillance image acquirer 11; a face image and face ID, which are output from the face image detector 12; and a feature amount, which is output from the feature amount generator 13. The generated output data is output to the surveillance server 30, the surveillant device 20, or another imager 10 through the network NW. The output data delivered to the surveillance server 30 or surveillant device 20 includes a priority, a suspicious person ID, and the aforementioned surveillance data 17. The priority is based on information output from the suspicious person discriminator 14. The priority is set to be high when it is judged that the target face image depicts a suspicious person. The suspicious person ID is a unique number that is set to identify a suspicious person, commonly used in the entire surveillance system, and retained after being associated with a specific feature amount in the suspicious person list 15. The output data delivered to another imager 10 includes a priority, a suspicious person ID, an imaging time, an imager ID, a face image, and a feature amount. However, the contents of the output data can be changed in compliance with system specifications. The data input/output 18 is controlled in such a manner that surveillance data having high priority is transmitted immediately without fail. Upon receipt of data from the surveillance server 30, the surveillant device 20, or another imager 10, the data input/output 18 outputs the received data to the data manager 16. In accordance with the data output from the data input/output 18, the data manager 16 updates the data in the suspicious person list 15, updates the control data 19a, or outputs an imaging time and imager ID to the controller 19. In accordance with the data output from the data manager 16, the controller 19 acquires a control procedure for the local imager 10 from the control data 19a and exercises control accordingly.

### <Surveillant Device 20>

The surveillant device 20 is, for example, a personal computer, and includes an input 21, an output 23, and a controller 22.

The input 21 is a mouse, a keyboard, or the like, and outputs input data based on a surveillant's operation to the controller 22.

The controller 22 includes, for instance, a CPU (Central Processing Unit), a RAM (Random Access Memory), a ROM (Read-Only Memory), a HDD (Hard Disk Drive), and an input/output circuit, and controls the operations of the input 21 and the output 23, and transmits and receives data through the network NW. In the present embodiment, the controller 22 operates in accordance with a surveillant's input operation, which is performed with the input 22, to generate face image data and face image selection data and output them to the surveillance server 30 or imagers 10 through the network NW.

The output 23 is a display. For example, the output 23 presents a surveillance screen, which is output from the surveillance server 30, or displays the data about a suspicious person, which is output from an imager 10.

### <Surveillance Server 30>

The surveillance server 30 includes, for instance, a CPU (Central Processing Unit), a RAM (Random Access Memory), a ROM (Read-Only Memory), a HDD (Hard Disk Drive), and an input/output circuit. Functionally, the surveillance server 30 is divisible into a surveillance image list display 31, a suspicious person list updater 32, a person retriever 33, a face image detector 34, a feature amount generator 35, a suspicious person list 36, a surveillance data memory 37, and a screen data generator 38.

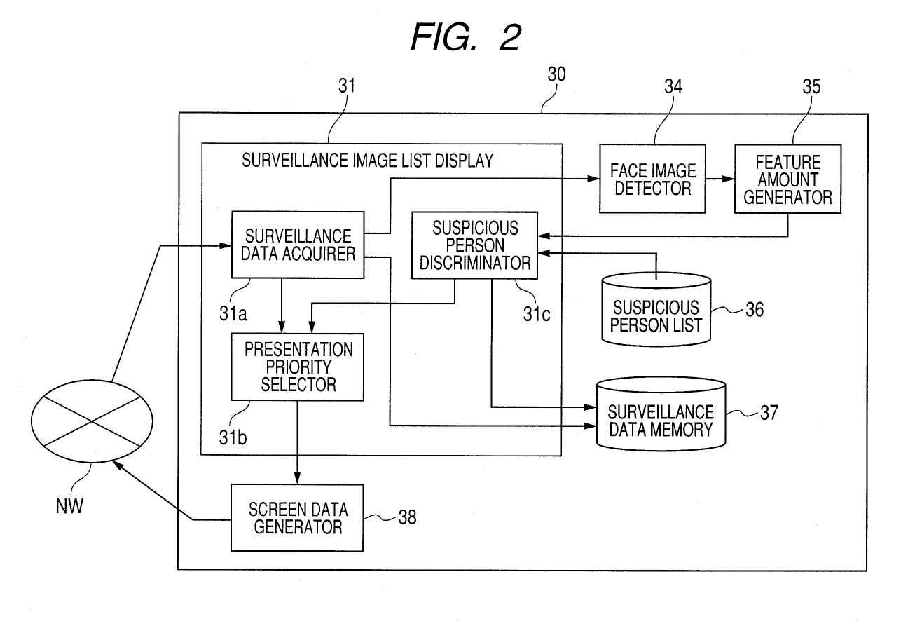

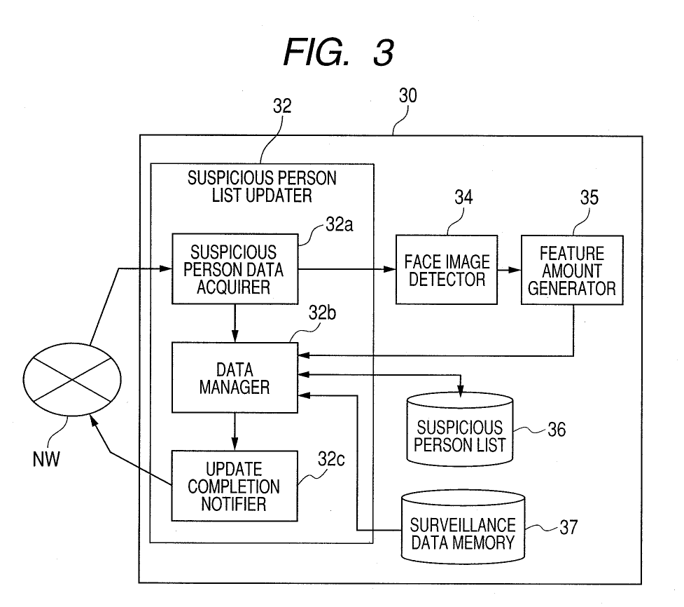

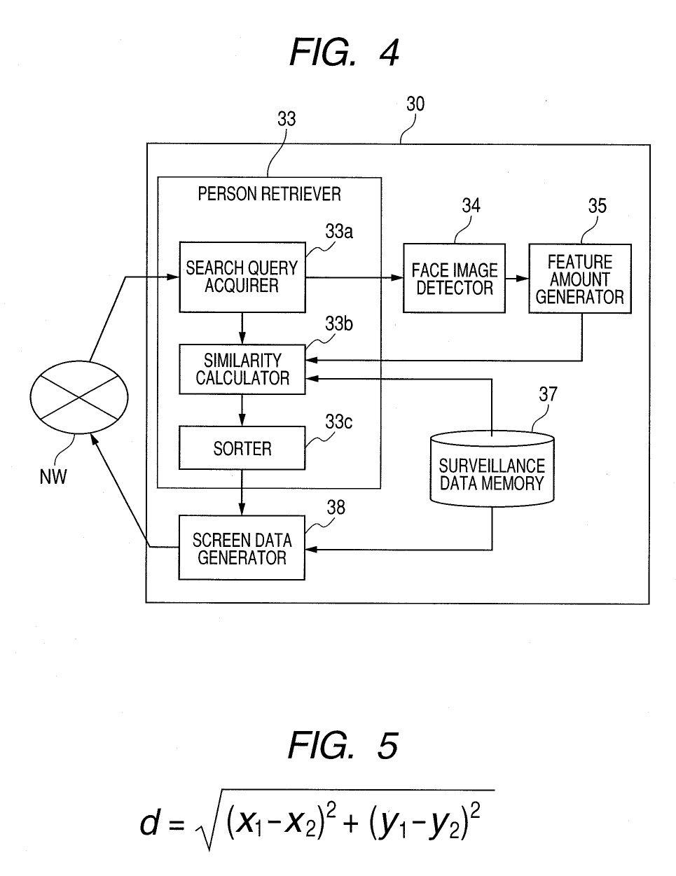

FIG. 2 is a schematic diagram illustrating the surveillance image list display 31. FIG. 3 is a schematic diagram illustrating the suspicious person list updater 32. FIG. 4 is a schematic diagram illustrating the person retriever 33.

As shown in FIG. 2, the surveillance image list display 31 displays a list of latest surveillance images that are acquired from the plural imagers 10 through the network NW, and presents the listed surveillance images to the surveillant. The surveillance image list display 31 includes a surveillance data acquirer 31a, a presentation priority selector 31b, and a suspicious person discriminator 31c.

The surveillance data acquirer 31a acquires the surveillance data 17, priorities, and suspicious person IDs output from the plural imagers 10 through the network NW, and outputs them to the presentation priority selector 31b and surveillance data memory 37. If the data acquired by the surveillance data acquirer 31a does not include face image information or feature amounts or if the feature amount of a face image is to be generated anew, a target surveillance image is output to the face image detector 34, and image data acquired through the feature amount generator 35 and suspicious person discriminator 31c is output to the presentation priority selector 31b. The process performed in the face image detector 34 is the same as the process performed in the earlier-described face image detector 12. More specifically, a surveillance image ID and a face image associated with a unique face ID are generated. However, the face image detector 34 and the earlier-described face image detector 12 do not have to use the same face detection method. Similarly, the process performed in the feature amount generator 35 is the same as the process performed in the earlier-described feature amount generator 13. Further, the process performed in the suspicious person discriminator 31c is the same as the process performed in the earlier-described suspicious person discriminator 14. The surveillance data memory 37 stores previous surveillance data for a period defined for a surveillance operation or until it runs out of storage space.

The presentation priority selector 31b selects a surveillance image for presentation by examining the priority, imaging time, and imager included in the surveillance data output from the surveillance data acquirer 31a or suspicious person discriminator 31c, and outputs the selected presentation surveillance image to the screen data generator 38. The rules for selection vary with the surveillant device 20 and can be defined from the surveillance device 20.

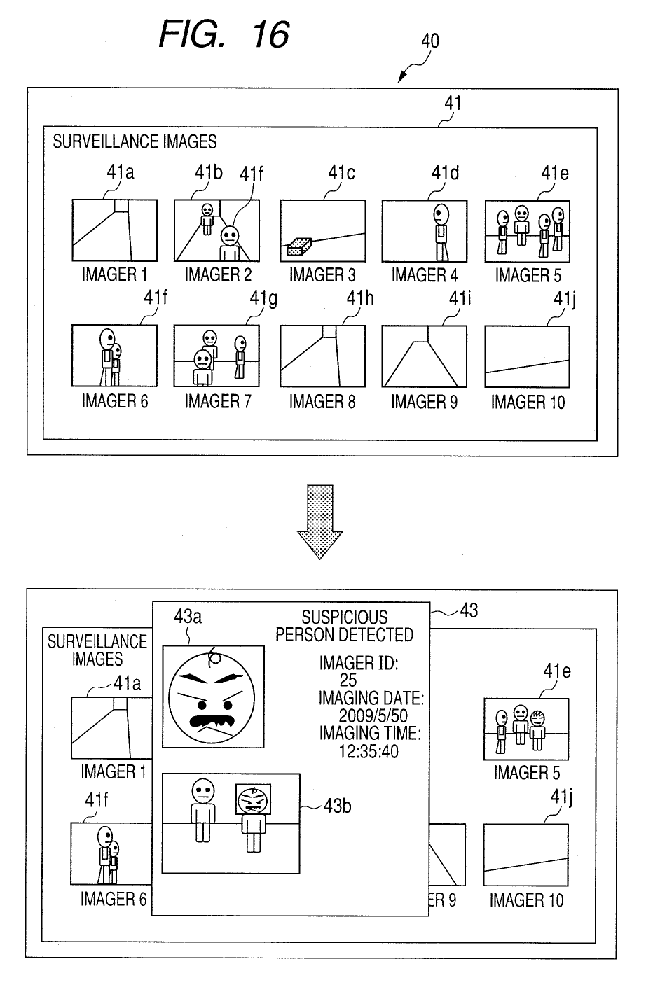

The screen data generator 38 is an example of a surveillance image list output that outputs a result produced by the presentation priority selector 31b, and generates screen data for displaying not only a surveillance image depicting a suspicious person but also surveillance images received from the plural imagers. FIG. 16 shows typical screens displayed by the screen data generator 38. The upper drawing in FIG. 16 shows a surveillance image list screen. This screen shows surveillance images 41a-41j picked up by the individual imagers. When a suspicious person is detected, the screen data generator 38 displays a screen 43 in addition to the surveillance image list screen as indicated by the lower drawing in FIG. 16. This additional screen 43 shows a surveillance image 43b depicting the suspicious person, a face image 43a of the suspicious person, and relevant information such as an imager ID and imaging time.

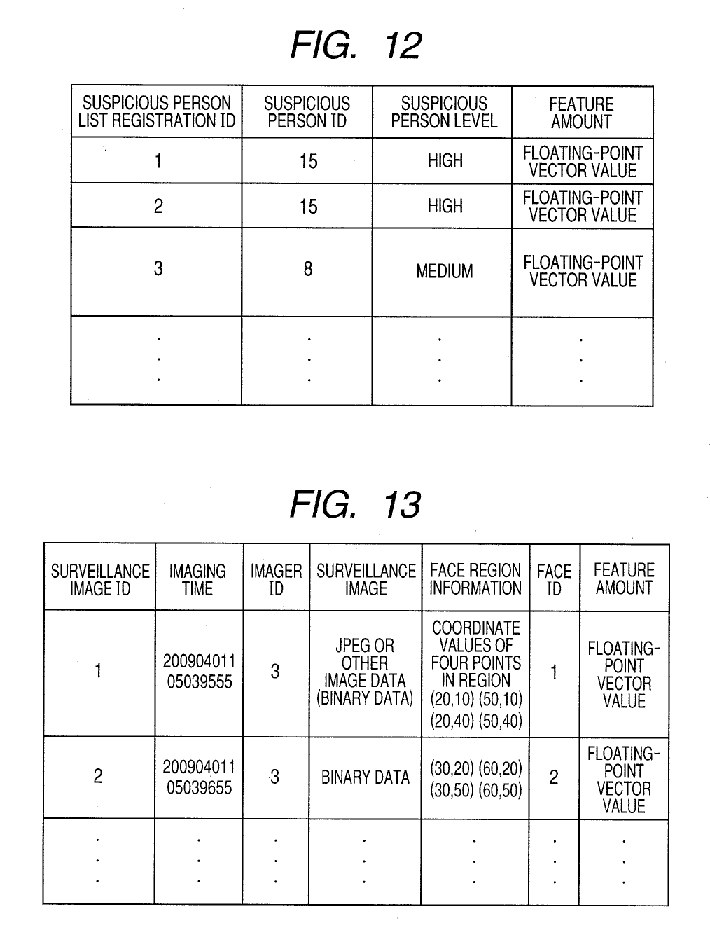

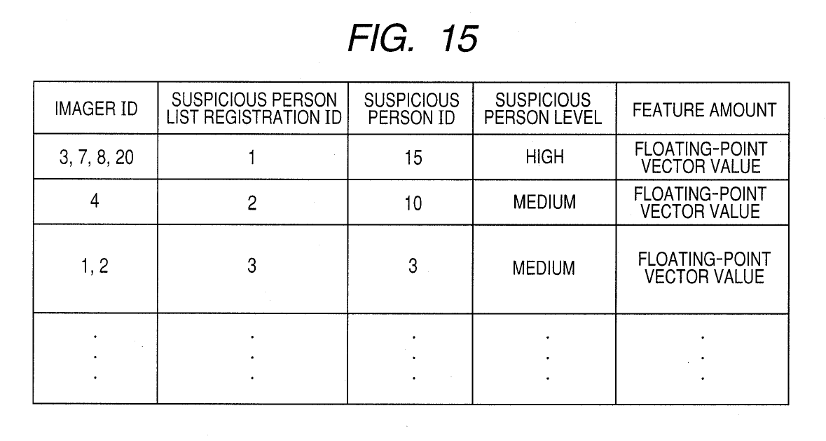

As shown in FIG. 3, the suspicious person list updater 32 updates the suspicious person list 36 in accordance with a command received from an imager 10 or the surveillant device 20 through the network NW, and includes a suspicious person data acquirer 32a, a data manager 32b, and an update completion notifier 32c. The data structure of the suspicious person list 36 is shown in FIG. 15. The data structure of the suspicious person list 15 is shown in FIG. 12. In the suspicious person list 36, the imager ID is associated with the information about a suspicious person in addition to data entries in the suspicious person list 15 of each imager. Therefore, the suspicious person lists 15 of the individual imagers are integrated into the suspicious person list 36. However, the values of the individual data entries are unique to the surveillance server and not equal to those in the suspicious person list 15. Further, the suspicious person list 36 does not have to include the entire data in the suspicious person list 15.

The suspicious person data acquirer 32a acquires a processing command, an imager ID, a priority, a suspicious person ID, a face image, a feature amount, and other data output from the imagers 10 and surveillant device 20 through the network NW, and outputs the acquired data to the data manager 32b. If the data acquired by the suspicious person data acquirer 32a includes neither a surveillance image ID of the surveillance data memory 37 nor face image information or feature amount, or if the feature amount of a face image is to be generated anew, a target surveillance image is output to the face image detector 34 as well, and a face image and feature amount are acquired from the feature amount generator 35 and output to the data manager 32b.

The data manager 32b updates the suspicious person list in accordance with a processing command output from the suspicious person data acquirer 32a or feature amount generator 35. If the processing command is “Add” or “Update,” the imager ID, priority, suspicious person ID, face image, feature amount, and other data output from the suspicious person data acquirer 32a or feature amount generator 35 are entered into the suspicious person list 36 for registration or update purposes. If, on the other hand, the processing command is “Delete,” the data corresponding to a suspicious person list registration ID output from the suspicious person data acquirer 32a or feature amount generator 35 is deleted from the suspicious person list. Further, if the data output from the suspicious person data acquirer 32a includes a surveillance data registration ID indicative of data stored in the surveillance data memory 37, a feature amount stored in the surveillance data memory 37 can be registered in the suspicious person list.

The update completion notifier 32c acquires process completion information from the data manager 32b, and transmits the process completion information to an imager 10 or the surveillant device 20 that has generated a request for suspicious person list update.

As shown in FIG. 4, the person retriever 33 conducts a similar image search by using the feature amount of a search query face image acquired from the surveillant device 20 through the network NW for the purpose of searching the surveillance data memory 37 for the same person as a person depicted by the search query face image, and includes a search query acquirer 33a, a similarity calculator 33b, and a sorter 33c.

The search query acquirer 33a acquires a search query output from the surveillant device 30 through the network NW, and outputs the acquired search query to the similarity calculator 33b. If the search query is a surveillance image or if the feature amount of a face image is to be generated anew, a target surveillance image is output to the face image detector 34, and a face image and feature amount are acquired through the feature amount generator 35 and output to the similarity calculator 33b.

The similarity calculator 33b calculates the similarity between a feature amount output from the search query acquirer 33a or feature amount generator 35 and a feature amount stored in the surveillance data memory 37. In the present embodiment of the present invention, the similarity is represented by a parameter that decreases with an increase in similarity between two feature amounts. A publicly known method can be used to calculate the similarity. When, for instance, the aforementioned brightness gradient is used for feature amounts, the mean-square distance between feature amounts determined from two face images can be used. When, for instance, the two feature amounts are f(x₁, y₁) and f(x₂, y₂), respectively, the mean-square distance d between them is \sqrt{(x₁−x₂)²+(y₁−y₂)²} as indicated by the equation in FIG. 5. The calculated similarity is output to the sorter 33c. Here, a surveillance data registration ID in the surveillance data memory 37 can also be used as a search query. If such a surveillance data registration ID is used as the search query, the feature amount of the surveillance data registration ID is acquired from the surveillance data memory 37, and the similarity between the acquired feature amount and another feature amount stored in the surveillance data memory 37 is calculated.

The sorter 33c sorts all similarities output from the similarity calculator 33b in ascending order (from the smallest similarity parameter value to the greatest). In other words, the sorter 33c sorts the feature amounts in the surveillance data memory 37 in order from the highest similarity to a search query face image to the lowest. Then, a predetermined number of feature amounts having relatively small similarity parameter values are selected from those arranged in ascending order of similarity parameter values, and output to the screen data generator 38.

The screen data generator 38 is an example of a search result output that outputs a result produced by the person retriever 33, and generates search result display screen data for displaying a surveillance image in the surveillance data memory 37 in accordance with a result generated from the sorter 33c.

Further, in accordance with a surveillance image stored in the surveillance data memory 37 or a face image retained by the surveillant device 20, the screen data generator 38 can also generate query face image designation screen data, which enables the surveillant to display a query image for a person search on the output 23 of the surveillant device 20. The generated search result display screen data and query face image designation screen data are output to the surveillant device 20 through the network NW.

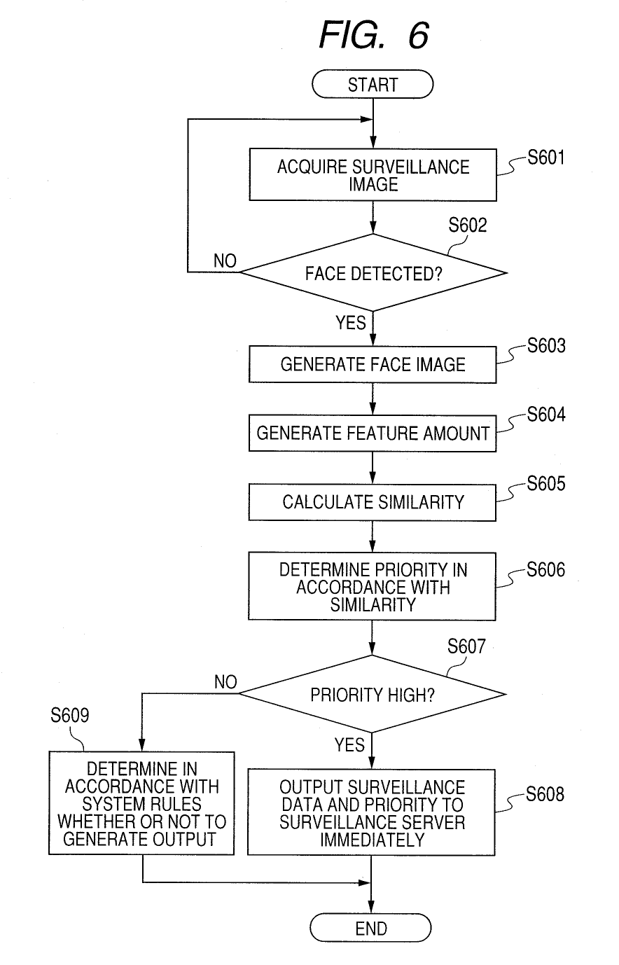

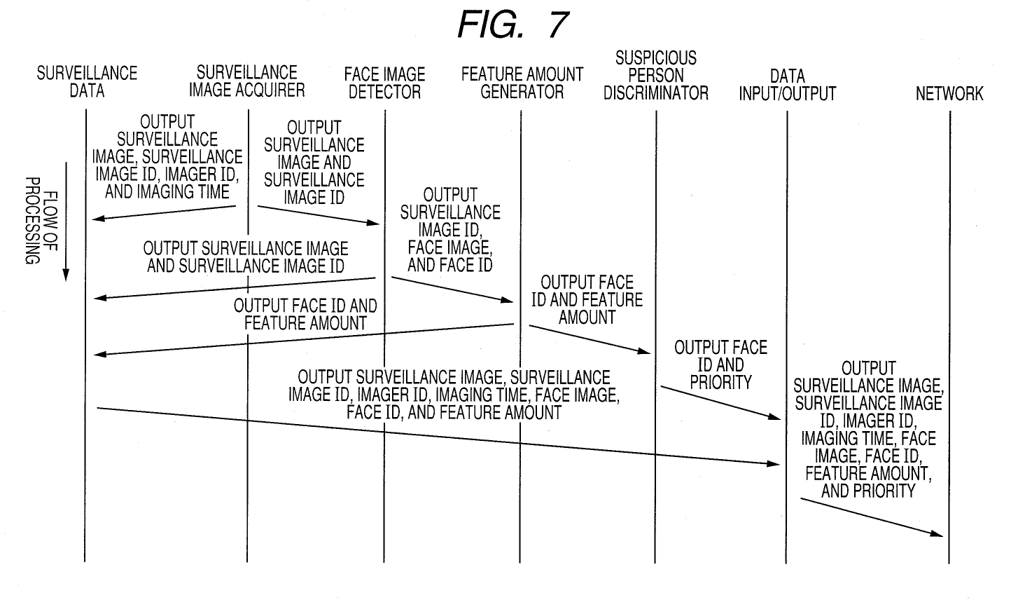

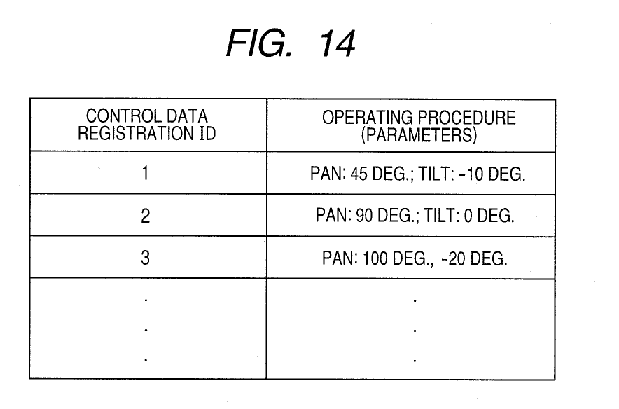

A first typical operation of an imager 10 according to the present embodiment of the present invention will now be described with reference to FIGS. 6 and 7 (and with occasional reference to FIG. 1). FIG. 6 is a flowchart illustrating a typical operation performed by an imager 10 according to the present embodiment of the present invention. FIG. 7 illustrates the flow of data during the operation indicated in FIG. 6. FIG. 12 shows the data structure of the suspicious person list 15. FIG. 13 shows the data structure of the surveillance data 17. FIG. 14 shows the data structure of the control data 19a.

First of all, as shown in FIGS. 6 and 7, the surveillance image acquirer 11 of an imager 10 acquires a surveillance image by picking up an image of a surveillance region (step S601), and outputs the acquired surveillance image to the face image detector 12 and surveillance data 17 together with a unique surveillance image ID. An imager ID and imaging time are also output to the surveillance data 17 and retained in addition to the surveillance image and surveillance image ID. The face image detector 12 generates a face image by detecting and cutting out a face region in the surveillance image (step S603), and outputs the generated face image to the feature amount generator 13 and surveillance data 17 together with a unique face ID. If no face region is detected from the surveillance image, the process for that surveillance image terminates. If plural face regions are detected from the surveillance image, face IDs are assigned to individual face images and sequentially output to the feature amount generator 13. The feature amount generator 13 generates the feature amount of a face image (step S604), and outputs the generated feature amount and the associated face ID to the suspicious person discriminator 14 and surveillance data 17. The suspicious person discriminator 14 calculates the similarity between the feature amount acquired from the feature amount generator 13 and a feature amount registered in the suspicious person list acquired through the data manager 16 (step S605). The suspicious person discriminator 14 then compares the calculated similarity against a predetermined threshold value to determine the priority of a target feature amount (step S606), and outputs the determined priority to the data input/output 18. In accordance with the priority acquired from the suspicious person discriminator 14, the data input/output 18 controls the output to the surveillance server 30. If the priority is high, step S608 is performed to output the surveillance data 17 and the priority to the surveillance server 30 through the network NW. If, on the other hand, the priority is not high, step S609 is performed to judge in accordance with the rules of a target surveillance system whether the surveillance data 17 and the priority should be output to the surveillance server 30. Typical rules would be such that the surveillance data 17 and the priority should not be output if, for instance, the priority is greater than a threshold value and the feature amount is similar to a feature amount that was output to the surveillance server 30 within a predetermined period of time. Meanwhile, the controller 19 controls the pan and tilt of the imager in accordance with the data structure of the control data 19a shown in FIG. 14.

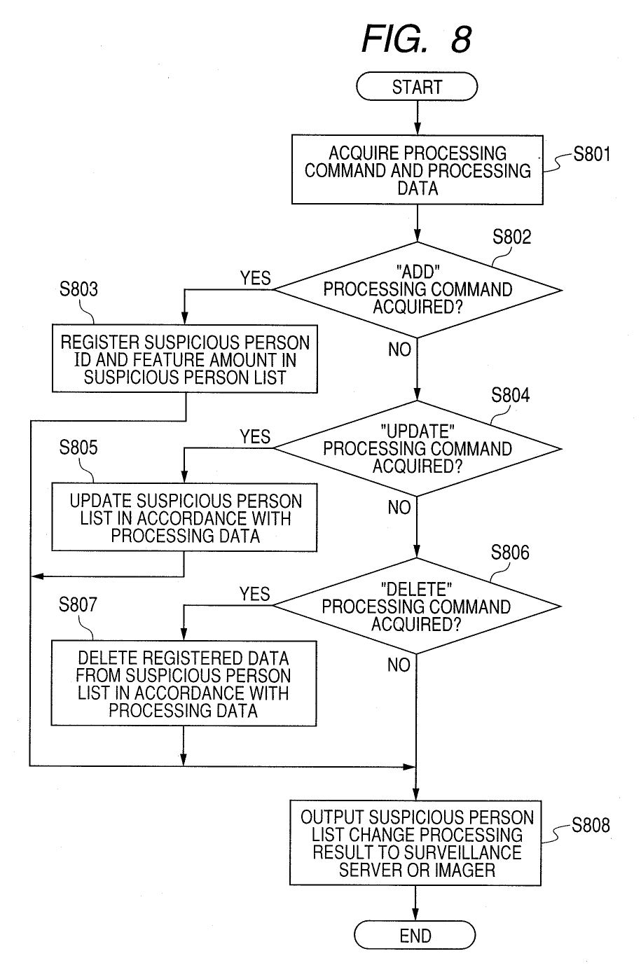

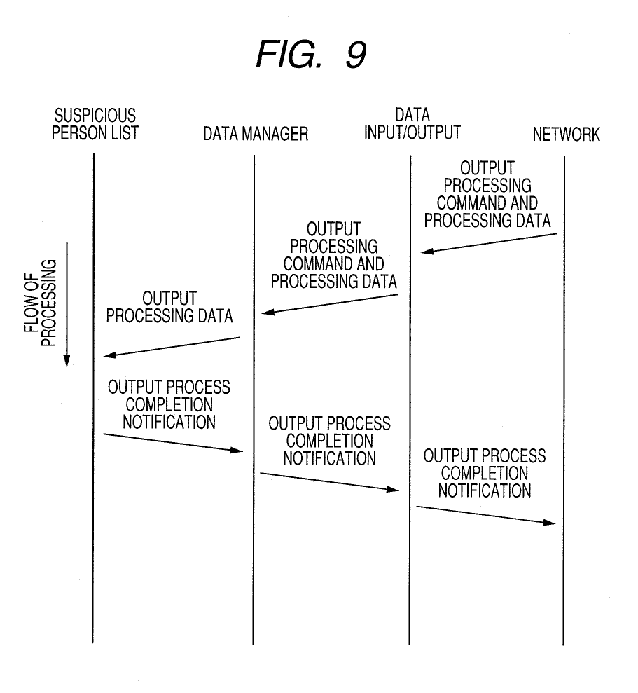

A second typical operation of an imager 10 according to the present embodiment of the present invention will now be described with reference to FIGS. 8 and 9 (and with occasional reference to FIG. 1). FIG. 8 is a flowchart illustrating a typical operation performed by an imager 10 according to the present embodiment of the present invention. FIG. 9 illustrates the flow of data during the operation indicated in FIG. 8.

As shown in FIGS. 8 and 9, the data input/output 18 acquires a processing command and processing data for the suspicious person list 15 from the surveillance server 30 or another imager 10 through the network NW (step S801), and outputs the acquired processing command and processing data to the data manager 16. The data manager 16 updates the suspicious person list 15 in accordance with the processing command. If the processing command is “Add,” the processing data includes a suspicious person ID and feature amount; therefore, step S803 is performed to additionally register the suspicious person ID and feature amount in the suspicious person list 15. If the processing command is “Update Feature Amount,” the processing data includes a suspicious person list registration ID, suspicious person ID, and feature amount; therefore, step S805 is performed to update the suspicious person ID and feature amount associated with the suspicious person list registration ID in the suspicious person list 15. If the processing command is “Delete,” the processing data includes a suspicious person list registration ID; therefore, step S807 is performed to delete data corresponding to the suspicious person list registration ID in the suspicious person list 15. After the suspicious person list 15 is updated by the processing command, a process completion notification indicating the completion of such an update is output to the data input/output 18. The data input/output 18 outputs the process completion notification to the surveillance server 30, which has issued the processing command, or to another imager 10 (step S808).

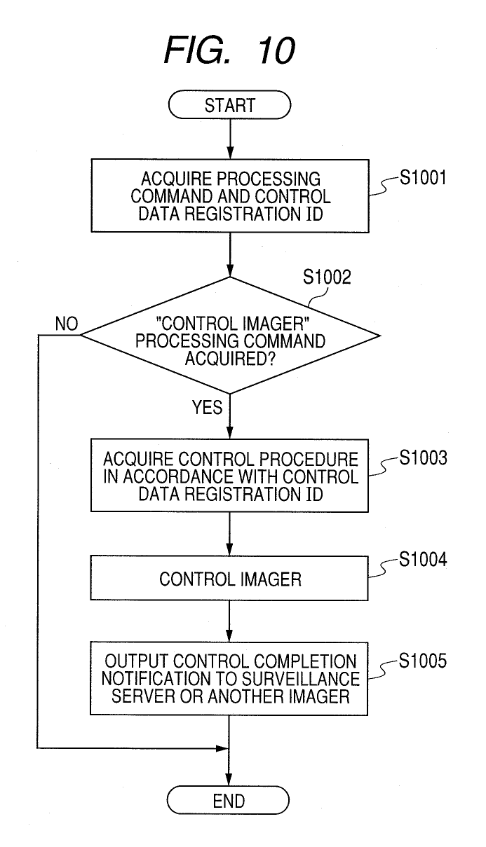

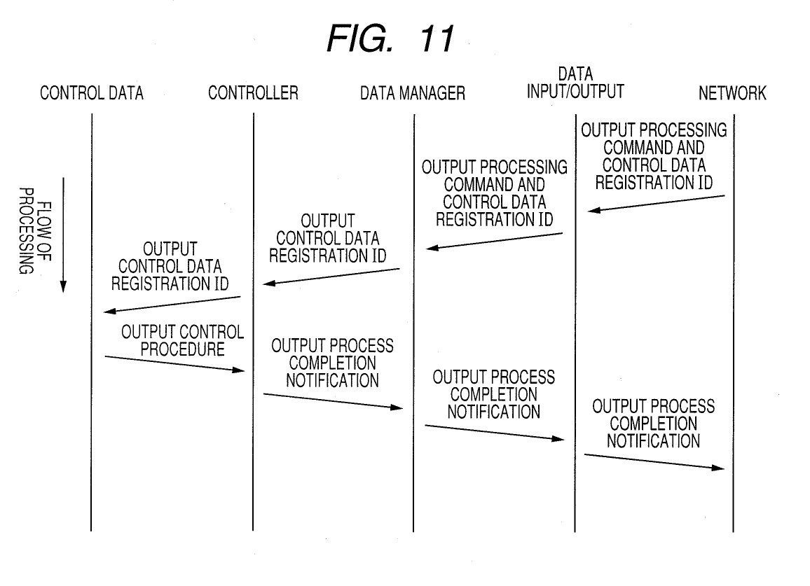

A third typical operation of an imager 10 according to the present embodiment of the present invention will now be described with reference to FIGS. 10 and 11 (and with occasional reference to FIG. 1). FIG. 10 is a flowchart illustrating a typical operation performed by an imager 10 according to the present embodiment of the present invention. FIG. 11 illustrates the flow of data during the operation indicated in FIG. 10.

As shown in FIGS. 10 and 11, the data input/output 18 acquires a processing command and a control data registration ID for the controller 19 from the surveillance server 30 or another imager 10 through the network NW (step S1001), and outputs the acquired processing command and control data registration ID to the data manager 16. If the processing command is “Control Imager,” the data manager 16 outputs the control data registration ID to the controller 19 (step S1002). The controller 19 outputs the control data registration ID to the control data 19a and acquires a relevant control procedure from the control data 19a (step S1003). The controller 19 then controls the local imager in accordance with the acquired control procedure (step S1004). Upon completion of control exercised in accordance with the acquired control procedure, the controller 19 outputs a control completion notification to the surveillance server 30, which has issued the processing command, or to another imager 10 through the data manager 16 or the data input/output 18 (step S1005).

What is claimed is:

1. An imager comprising:
a surveillance image acquirer that images a surveillance region to acquire a surveillance image;
a face image detector that detects a face image in the surveillance image;
a feature amount generator that generates the feature amount of the detected face image;
a suspicious person list that stores feature amounts of face images of suspicious persons; and
a suspicious person discriminator that calculates the degree of similarity between a feature amount in the surveillance image and a feature amount in the suspicious person list, and judges whether the detected face image in the surveillance image depicts a suspicious person.

2. The imager according to claim 1, further comprising:
a data input that acquires data transmitted from an external device;
wherein the transmitted data is update information for the suspicious person list.

3. The imager according to claim 2, wherein the update information at least adds data to the suspicious person list, updates a feature amount, or deletes data.

4. The imager according to claim 1, further comprising:
a controller that controls the pan and tilt of the imager; and
control data that includes operating procedures for the controller;
wherein an operating procedure is selected from the control data in accordance with an instruction from the external device to control the imager.

5. The imager according to claim 1, wherein the suspicious person discriminator includes a unit that determines priority in accordance with the degree of similarity, and a data output that transmits data to a surveillance server; and controls a sequence of transmission to the surveillance server in accordance with the priority.

6. A surveillance system comprising:
an imager; and
a surveillance server;
wherein the imager includes
a surveillance image acquirer that images a surveillance region to acquire a surveillance image
a face image detector that detects a face image in the surveillance image,
a feature amount generator that generates the feature amount of the detected face image,
a suspicious person list that stores feature amounts of face images of suspicious persons,
a suspicious person discriminator that calculates the degree of similarity between a feature amount in the surveillance image and a feature amount in the suspicious person list, and judges whether the detected face image in the surveillance image depicts a suspicious person, and
a data input that acquires data transmitted from an external device;
wherein the surveillance server includes
a database that stores a suspicious person list, and
a suspicious person list updater that updates the suspicious person list; and
wherein updated suspicious person information in the surveillance server is transmitted to the data input of the imager to update the suspicious person list in the imager.
